(19) United States
(12) Patent Application Publication
(10) Pub. No.: US 2024/0301326 A1
(43) Pub. Date: Sep. 12, 2024

(54) CAGELESS SELF-ADHESIVE LAVATORY CLEANING COMPOSITION

(71) Applicant: Reckitt & Colman (Overseas) Hygiene Home Limited, Slough, Berkshire (GB)

(72) Inventors: Kapim Kumar BAGGA, Montvale, NJ (US); Patricia Cristina Piedade GUEDES, Montvale, NJ (US); Madhavi VADLAMUDI, Montvale, NJ (US)

(21) Appl. No.: 18/578,861

(22) PCT Filed: Jul. 22, 2022
(86) PCT No.: PCT/GB2022/051924

§ 371 Date: Jan. 12, 2024

(30) Foreign Application Priority Data
Jul. 23, 2021 (GB) 2110629.9

(51) Int. Cl. C11D 3/04; C11D 1/02; C11D 3/00; C11D 3/40; C11D 3/50; C11D 17/00

(52) U.S. Cl. CPC C11D 3/046; C11D 1/02; C11D 3/0084; C11D 3/40; C11D 3/50; C11D 17/0056; C11D 2111/14

(57) ABSTRACT

The present invention is directed to a stable cageless self-adhesive block composition and methods of use thereof, the composition containing (a) from about 10% to about 60% by weight of an inorganic sodium salt; (b) from about 15% to about 75% by weight of an anionic surfactant; (c) from about 0.1% to about 10% by weight of an adhesion promoter; (d) from about 0.5% to about 10% of a chelating agent, (e) an anti-oxidant, (f) a dye, and (g) a fragrance, wherein when applied to the walls of a sanitary appliance, said block composition stays adhered to the wall for at least a period of up to 7, 10, 14, 21, 28 or 60 days.

### FIELD OF INVENTION

The present invention relates generally to solid, semi-solid or malleable block compositions for direct application to a sanitary appliance having a prolong duration of adherence to the sanitary appliance and prolong shelf-life stability. The present invention is further directed to the kit, the processes for manufacturing, and using the same for a sustainable lavatory care effect.

### BACKGROUND

There are a variety of cleaning compositions that have been described in the art for cleaning hard surfaces of the sanitary appliances located in bathrooms such as toilet bowls, urinals, and even bathroom tiles. Sanitary appliances, for example hygienic toilet bowls or urinals fixed to a wall, have to be subjected to repeated cleaning and disinfecting operations in order to be able to maintain adequate hygienic sanitary conditions. The prior art typically describes hanging sanitary agents by means of hooking devices positioned in the toilet bowl where the emission of the sanitary agent occurs at each discharge flush operation into the bowl. Such compositions are typically combinations of an acidic component, a dye and fragrance that are flushed with water to produce their desired aesthetic, cleaning, disinfecting, and deodorizing effects.

Adherable sanitary agents have also been described in the art. At least one shortcoming of such products is related to their inconsistent properties, shelf stability, foamability and failures in their adhesiveness during and/or after the flushing. Moreover, they typically require a customized applicator made of environmentally unfriendly material.

EP 1 318 191 discloses a viscous gel as a sanitary composition containing an adhesion promoter compounds from the group of oligo- or polyethylene oxide and/or block polymers comprising oligo- and/or polypropylene oxide and/or oligo- and/or polybutylene oxide, the aryl ethoxylates or the alkylaryl ethoxylates. The disclosure is directed to a gel composition that would require an applicator.

U.S. Pat. No. 6,667,286, which is herein incorporated by reference, discloses a sanitary composition for cleaning and/or disinfecting and/or releasing an odorant, that contains an adhesion promoter, water anionic and/or non-ionic and/or amphoteric surface-active agent. The adhesion promotor used was xanthum gum and/or alkyl ethoxylate. The disclosed sanitary agents requires an applicator.

U.S. Pat. No. 8,461,093 which is herein incorporated by reference in its entirety, describes sanitary compositions that can be applied directly on the sanitary object, adheres, and is flushable only after a large number of flushes. The agent comprises fillers from the group of surfactants and a bonding agent, wherein the bonding agent is selected from the group of polyalkylene derivatives, hydrogenated polystyrol derivatives, copolymers from the group of monoalkyl esters of poly(methyl vinyl ether/carbonic acid anhydrides, olefin homopolymers, and copolymers of two or more olefins. There is no disclosure of using alkylglycoside or antioxidants in such formulations. The disclosed compositions also requires an applicator to be applied to the sanitary applicances.

U.S. Pat. No. 8,835,371, which is herein incorporated by reference in its entirety, discloses an adherable sanitary composition having an adhesion promoter selected from hydrogenated polystyrene derivatives and olefin homopolymers and copolymers of two or more olefins, where the olefin homopolymers and copolymers may also be partially hydrogenated. The viscosity of the agent is at least 30 Pas, measured using a Haake viscometer, plate/plate system, plate diameter 10 mm, at a shear gradient of 2.62 s⁻¹ and 20° C. The sanitary composition requires an applicator.

U.S. Pat. No. 8,927,477 which is herein incorporated by reference, discloses a sanitary composition, designed to adhere to a wall of the sanitary appliance and including a treatment compound having at least an active element for treatment of the sanitary appliance. The body has an external surface thereof covered by a polymeric film. However, the exemplified external film was described to be of polyvinyl acetate, that are typically non-water soluble. Furthermore, the formulations displayed poor shelf stability and unpredictable adhesive properties.

Despite advancement in the art, technologies based on providing adherable compositions which are used directly on the surface of a sanitary applicant often are not wholly effective and frequently lead to accumulation and scaling of undesirable grime and mineral continues to persist and complicate easy access to good hygiene among many consumers. The various features of the invention address these technical shortcomings.

### SUMMARY OF THE INVENTION

The present invention relates to a hard surface cleaning composition, preferably an adhesive malleable block composition, providing ease of application and, preferably, a longer duration of adherence on the sanitary object such as a toilet bowl, cistern, or the like. The products described herein further display superior shelf-life stability making it suitable for direct application into the bowl without the need of an applicator.

In at least one aspect of the present invention, the present product is directed to a composition wrapped in a polymeric film that can be applied directly on the sanitary object when the object is moist and further stay on such object for at least a period of 7, 10, 14, 21, 28, up to 60 days. Such direct application can be achieved without any applicator and merely by directly pressing the product against the wall of the sanitary appliance. In at least one embodiment the product adheres on the walls of a toilet bowl made of ceramic, metal, or otherwise polymeric construct and only be flushed away after at least 20, 30, 60, 120, 240, up to 480 flushing operations.

In at least another aspect, the composition according to the present invention contains a sodium salt filler, an anionic surfactant, a chelating agent, adhesion promoter, an antioxidant and optionally a dye and fragrance. The composition is wrapped and sealed with a water-soluble film to create a block unit for direct application to the wall of a sanitary object.

In some embodiments, the composition of the present invention is substantially free of any non-ionic surfactant source. In some embodiments, the composition is free of any non-ionic surfactant. In some embodiments, the compositions of the present invention may optionally contain at least one non-ionic surfactant. In some embodiment, the composition contains an anionic surfactant, but is free of any other sources of surfactants. In some embodiments, the composition of the present invention is free of any other sources of surfactants, but for the suitable anionic surfactants.

In some embodiments, the block composition unit according to the present invention is directed to solid and/or malleable lavatory cleaning compositions containing: (a) from about 10% to about 60% by weight of an inorganic sodium salt; (b) from about 10% to about 80%, preferably about 15% to about 75% by weight of an anionic surfactant; (c) from about 0.1% to about 10% by weight of an adhesion promoter; (d) from about 0.05% to about 10% of a chelating agent, (e) from about 0.05% to about 1.0% by weight of an antioxidant; and wherein said composition is wrapped and sealed with a water-soluble adhesive film. The present block composition unit is capable of adhering to sanitary object when applied directly without the need to use an applicator. In at least one embodiment, according to the present invention, the composition is substantially free, preferably free of any non-ionic surfactant.

In some embodiments, the block composition according to the present invention is directed to solid and/or malleable lavatory cleaning compositions containing: (a) from about 12.5% to about 45% by weight of an inorganic sodium salt; (b) from about 25% to about 75% by weight of an anionic surfactant, preferably from about 45% to about 70%; (c) from about 0.5% to about 5.0% by weight of an adhesion promoter, preferably from about 0.5% to about 3%, more preferably from about 1.0% to about 2%; (d) from about 0.5% to about 3% of a chelating agent, and/or (e) from about 0.1% to about 1.0% by weight of an antioxidant, preferably from about 0.1% to about 0.5%, more preferably from about 0.1% to about 0.3%. The composition according to this embodiment is then wrapped and sealed with a water-soluble adhesive film having a thickness ranging from 20 to 100 microns to form the self-adhesive block unit. The composition is substantially free, preferably free of non-ionic surfactants.

In an embodiment, said composition is in the form of a hexagonal shape block wrapped and sealed by a water-soluble film and, preferably, is capable of adhering to sanitary object when applied directly. In certain embodiments, the water-soluble film has a thickness of about 20 to about 100 microns. In some embodiments, the thickness of the water-soluble film may vary at the top, sides or bottom part of the block.

In some embodiments, the block compositions according to the present invention contain (a) sodium sulfate in amount of about 15% to about 42.5% by weight, (b) sodium dodecyl benzene sulfate in amount of about 45% to about 55% by weight, (c) sodium lauryl sulfate is about 17.5% to about 22.5% by weight, (d) trisodium citrate in amount of about 1% to 3% by weight, (d) n-methyl-alkyl glucamide in amount of about 1.0% to 2.0% by weight, (e) sodium phytate in amounts of about 0.1% to about 0.3% by weight. In some embodiments, the composition may contain a bittering agent, a fragrance and a dye. In such embodiment, the block composition is free of any other sources of surfactants, preferably free of any sources of non-ionic surfactants. In such embodiment, the composition is further wrapped with a polyvinyl hydroxide film.

In some embodiments, the inorganic sodium salt is sodium sulfate or sodium chloride and the anionic surfactant is selected from the group of sodium dodecylbenzene sulfonate (SDBS), sodium alpha olefin sulfonate, sodium dodecyl sulfate, sodium laurate sulfate, sodium lauryl sulfate (C₁₀-C₁₆), sodium stearate, and magnesium laureth sulfate or any combinations thereof. In some embodiments, the composition optionally comprises any one of a dye, a fragrance, a biocide, preservatives, bitterness flavorants, absorbants or any mixtures thereof.

In some embodiments, anionic surfactant, chelating agent, adhesion promoter and the antioxidant are present in the block composition at a ratio of 125 to 375:2.5 to 15:2.5 to 15:0.5 to 1.5 respectively on a weight basis. In some embodiments, the ratio of chelating agent, adhesion promoter and the antioxidant are 175 to 350:9 to 11:7 to 9:0.8 to 1.2 respectively. In preferred embodiments, the ratio of the anionic surfactant, chelating agent, the adhesion promoter and the antioxidant is 350:10:7.5:1, respectively on the weight basis.

In another embodiment, the chelating agent, adhesion promoter and the antioxidant are present in a ratio of 2.5 to 15:2.5 to 15:0.5 to 1.5 respectively on a weight basis. In some embodiments, the ratio of chelating agent, adhesion promoter and the antioxidant are 9 to 11:7 to 9:0.8 to 1.2 respectively on weight basis. In preferred embodiments, the ratio of the chelating agent, the adhesion promoter and the antioxidant is 10:7.5:1, respectively on weight basis.

In another embodiment, a composition according to the present invention has less than 5% water content. In other composition, a composition according to the present invention is substantially free of water.

In yet another embodiment of the invention, the block unit is described that when adhered on the walls of a toilet bowl made of ceramic, metal, or otherwise polymeric construct can only be detached after at least 20, 30, 60, 120, 240, up to 480 flushing operations. In some embodiments, the composition is in the form of a block unit having a weight ranging from about 5 g to 50 g.

In another embodiment, the present invention is directed to a self-adhesive block composition unit consisting essentially of (a) an inorganic sodium salt; (b) at least 15% to 75% by weight of an anionic surfactant; (c) from about 0.5% to about 3% by weight of an adhesion promoter; (d) from about 0.5% to about 3% of a chelating agent, (e) from about 0.1% to about 1.0% by weight of an antioxidant; and wherein said composition is in the form of a hexagonal shape block wrapped and sealed by a water-soluble film and is capable of adhering to sanitary object when applied directly. In certain embodiments, the water-soluble film has a thickness of about 20 to about 100 microns. In some embodiments, the block composition is substantially free, preferably free of non-ionic surfactant. In some embodiments, the block composition is substantially free, from water.

In another embodiment, the present invention is directed to a cageless self-adhesive block composition consisting essentially of (a) from about 15% to about 45% by weight of an inorganic sodium salt; (b) from about 25% to about 75% by weight of an anionic surfactant; (c) from about 0.5% to about 3% by weight of an adhesion promoter; (d) from about 0.5% to about 3% of a chelating agent, (e) from about 0.1% to about 1.0% by weight of an antioxidant; and wherein said composition is in the form of a hexagonal shape block wrapped and sealed by a water-soluble film and is capable of adhering to sanitary object when applied directly. In certain embodiments, the water-soluble film has a thickness of about 20 to about 100 microns preferably less than 50, more preferably less than 35, and most preferably about 30 microns. In some embodiments, the thickness of the water-soluble film may vary at the top, sides or bottom part of the block. In some embodiments, the sodium salt is sodium sulfate; anionic surfactant is sodium dodecylbenzene sulfonate (SDBS) and/or sodium lauryl sulfate, the adhesion promoter is n-methyl-alkyl glucamide, and the antioxidant is sodium phytate.

In another aspect, the present invention is directed to a method of cleaning a sanitary appliance and hard surfaces comprising creating a moist surface on the wall of a sanitary appliance, placing a self-adhesive block composition according to the first aspect of the present invention, to the walls of a sanitary applicant by directly applying the composition to the sanitary appliance, triggering a flushing operation to release the ingredients of the block composition, wherein the block composition stays adhered to the sanitary object for at least a period of 7, 10, 14, 21, 28, up to 60 days. In certain embodiments, the composition can stay adhered to the object for at least a period of up to 7, 10, 14, 21, 28, or 60 days. In other embodiments, the composition would maintain its stability and adhesiveness for up to 105 weeks at room temperature and room relative humidity. In other embodiments, the composition maintains its stability and adhesiveness for at least 2 days up to 12 weeks under accelerated conditions at 40 (+2° C.) at 75 (+0.5) % Relative Humidity (RH) (accelerated) conditions. By “stable” or “conformed stability” it is meant that a product according to the present invention, maintains its shape, form, hardness, consistency, dimensions, and/or whether it converts from solid to a liquid dispersion, as compared to its original control counterpart kept in room temperature.

In some embodiments, the flushing operation is triggered up to 15 times a day. In certain embodiments, the flushing operation is triggered 5, 6, 7, 8, 9, 10, 11 or 12 times a day. In some embodiments, the method further includes the step of applying water to remove undesirable scaling and odor in the area of interest.

In another aspect, the present invention provides for blister pack kits containing such block composition units, methods of using such block units and also methods of manufacturing the block units of the present invention.

### DETAILED DESCRIPTION OF THE INVENTION

Unless defined otherwise, all technical and scientific terms used herein have the same meaning as is commonly understood by one of skill in the art to which this invention belongs and shall be understood to have the meanings described below. All publications and patents referred to herein are incorporated by reference in their entirety. Unless otherwise specified, a reference to a particular compound includes all ionic, salt, solvate (e.g., hydrate), protected forms, and other stereoisomers thereof, isomeric forms, including racemic and other mixtures thereof.

As used herein, “about” will mean up to plus or minus 5% of the particular term.

As used herein, the term “biocide” refers to any material that is capable of killing any of the microorganisms: bacteria, fungus, archaea, protozoa, algae, parasites, virus, pathogenic or non-pathogenic, which may include additional compounds having antiviral, antimicrobial, antibacterial, antifungal, and/or antiparasitic activities.

As used herein, “consisting essentially of” refers to excluding other active ingredients but including the recited optional excipients.

As used herein, “flushing operation’ refers to the force of flushing water in the toilet generated by the stream of flush water upon single application of the flush handle to activate the gravitational release of the water from the water tank or cistern to the toilet bowl.

As used herein, “sanitary appliance” generally refers to toilet bowl, urinal, fixtures and similar objects in lavatory.

By the term “substantially free” it is meant that the final composition contains less than 2.5% of the total weight of the respective composition to the extent that it could be detected by general quantitative assays known in the art for detection of such ingredient in the final composition. For example, the phrase substantially free of water would mean that the respective composition contains less than 2.5% water. By the term “free” it is meant that the final composition is free of any traces of the identified ingredient to the extent that it could be identified using the same assays as described herein above.

The present inventors have discovered that the products according to the present invention when applied directly to hard surface areas of a sanitary appliance can stay adhered to the appliance after at least 20, 30, 60, 120, 240, up to 480 flushing operation. In at least one aspect of the compositions of the present invention can be applied directly on the sanitary appliance walls, preferably when the wall is moist. In some embodiments, the composition can stay adhered to the object for at least a period of 7, 10, 14, 21, 28, up to 60 days. In certain embodiments, the composition can stay adhered to the object for at least a period of up to 7, 10, 14, 21, 28, 60 days when subjected to up to 15 times a day flushing operation. In at least one embodiment the composition adheres on the walls of a toilet bowl made of ceramic, metal, or otherwise polymeric construct and only be flushed away after at least 20, 30, 60, 120, 240, up to 480 flushing operations.

To that extent, in some embodiments, the flushing operation is triggered up to 15 times a day. In certain embodiments, the flushing operation is triggered 5, 6, 7, 8, 9, 10, 11 or 12 times a day. In some embodiments, the method further includes the step of applying water to remove undesirable scaling and odor in the area of interest.

At least one aspect of the present invention relates to a cageless cleaning compositions for direct application to a sanitary object comprising an anionic surfactant, a chelating agent, an adhesive promoter, an antioxidant, an inorganic filler, a fragrance, a dye, wrapped in a water-soluble film. In a preferred embodiment, the composition of the present invention is an extruded malleable block containing an anionic surfactant, a chelating agent, an adhesive promoter, an antioxidant, an inorganic filler, a fragrance, a dye, wrapped in a water-soluble film. In certain embodiments, the formulation may further contain preservatives; pH buffering agents; germicides, fungicides; bitter flavorants and absorbents.

In at least another aspect, the composition according to the present invention contains a sulfate filler, an anionic surfactant, a chelating agent, a non-ionic adhesion promoter, an antioxidant and optionally a dye and fragrance. In some embodiments, the composition is wrapped and sealed by a water-soluble film to create a block unit for direct application to the wall of a sanitary appliance.

The compositions of the present invention contain at least one anionic surfactant from about 10% to about 80%, preferably about 15% to about 75% by weight of the composition. In certain embodiments, the compositions of the present invention may optionally contain a non-ionic surfactant in amounts less than 5%, preferably less than 2.5% by weight of the composition. In some embodiments, the composition of the present invention is free of any other sources of surfactants. In some embodiments, the composition of the present invention is less than 2% of any non-ionic surfactant.

In some embodiments, the composition according to the present invention is directed to solid and malleable lavatory cleaning compositions containing: (a) from about 10% to about 60% by weight of an inorganic sodium salt; (b) from about 10% to about 80%, preferably about 15% to about 75% by weight of an anionic surfactant; (c) from about 0.1% to about 10% by weight of an adhesion promoter; (d) from about 0.05% to about 10% of a chelating agent, (e) from about 0.05% to about 1.0% by weight of an antioxidant; wherein the composition is wrapped and sealed by a water-soluble film and is capable of adhering to sanitary object when applied directly against the wall of a sanitary appliance. In some embodiments, the compositions of the present invention optionally contain one non-ionic surfactant in amounts up to 5%, preferably up to 2.5% by weight of the composition, but most preferably less than 2% by weight of the composition.

In some embodiments, the composition according to the present invention is directed to solid and malleable lavatory cleaning compositions containing: (a) from about 12.5% to about 45% by weight of an inorganic sodium salt; (b) from about 25% to about 75% by weight of anionic surfactants, preferably from about 45% to about 70%; (c) from about 0.5% to about 5% by weight of an adhesion promoter, preferably from about 0.5% to about 3%, more preferably from about 1.0% to about 2%; and/or (d) from about 0.5% to about 3% of a chelating agent, and/or (e) from about 0.1% to about 1.0% by weight of an antioxidant, preferably from about 0.1% to about 0.5%, more preferably from about 0.1% to about 0.3%. In some embodiments, the total amount of all non-ionic surfactants is less than 2.5% by weight of the composition.

In some embodiments, the compositions consists essentially of a sodium salt, an anionic surfactant, a chelating agent, an adhesive promoter, an antioxidant, a dye and a fragrance wrapped in a water-soluble film. In some embodiments, the compositions consists of one sodium salt, an anionic surfactant, a chelating agent, an adhesive promoter, an antioxidant, a dye and a fragrance, wherein the anionic surfactant is sodium dodecyl benzene sulfonate and the adhesion promoter is n-methyl-alkyl glucamide. In the case of dye, the amounts will be adjusted based on the desired consumer effect.

In some embodiments the composition has a weight ranging from about 1 g to about 50 g. In some embodiments, the composition is an extruded block having a weight ranging from about 5 g to 25 g, and preferably 7.5 to 15 g.

In some embodiments, the composition is wrapped by a water-soluble film to make a block unit form. The block unit may be in a solid, semi-solid or malleable, dough-like composition for direct application to a sanitary appliance that has a prolong duration of adherence to the surface of the sanitary appliance to which it is applied. The block unit according to the present invention can be formed into any shape, such as a sachet, sphere, cylinder, cube, cuboid, triangle, oval, circular, rectangle or the like. In some embodiments, the shape may be a modified geometrical shape where the base of the shape is a hexagon, square, circular, triangular, or oval, but the block unit and the sides thereof creates an alternative appearance such as a rounded droplet, cuboid, hexagonal or cylindrical shape. The dimensions of the unit dose may vary having a length of 0.5 to 25 cm, especially 1.5 to 15.0 cm, a width of 2.0 to 10.0 cm, and a height of 0.1 to 5 cm. However, there is no theoretical limitation, in either size, amount or shape so long as it can be adhered to the wall of a sanitary appliance for sufficient duration of time as intended herein.

In a preferred embodiment, the composition of the present invention is an extruded malleable block containing an anionic surfactant, a chelating agent, an adhesive promoter, an antioxidant, an inorganic filler, a fragrance, a dye, wrapped in a water-soluble film, where the water soluble film has different thickness at different sides surrounding the block. In certain embodiments, the block may further contain preservatives; pH buffering agents; germicides, fungicides; bitter flavorants and absorbents within the composition itself or as a part of the external water-soluble film.

In some embodiments, the compositions consists essentially of one sodium salt, two anionic surfactants, a chelating agent, an adhesive promoter, an antioxidant, a dye and a fragrance wrapped in a water-soluble film. In other embodiments, the composition consists of sodium sulfate, sodium dodecyl benzene sulfonate, sodium lauryl sulfate, n-methyl-alkyl glucamide, a chelating agent, an antioxidant, a dye and a fragrance. In yet another embodiment of the invention, a block unit is described that when adhered on the walls of a toilet bowl made of ceramic, metal, or otherwise polymeric construct can only be detached after at least 20, 30, 60, 120, 240, up to 480 flushing operations. In some embodiments, the composition is in the form of a block unit having a weight ranging from about 5 g to 50 g. In some embodiments, the unit is finally dissolved and flushed away after being detached from the wall following its respective duration of time that it had adhered to the wall of the sanitary.

In another embodiment, the present invention is directed to a self-adhesive block composition consisting essentially of (a) an inorganic sodium salt; (b) at least 10% to 80% by weight of anionic surfactants, preferably between 25% to 75%; (c) from 0.5% to 3% by weight of an adhesion promoter; (d) from 0.5% to 3% of a chelating agent, (e) from 0.1% to 1.0% by weight of an antioxidant; and wherein said composition is in the form of a hexagonal shape block wrapped and sealed by a water-soluble film and is capable of adhering to sanitary object when applied directly. In certain embodiments, the surfactants are selected from the group consisting of sodium dodecyl benzene sulphonate and sodium lauryl sulfate or mixtures thereof. In certain embodiments, the water-soluble film has a thickness of about 20 to about 100 microns. In some embodiments, the block composition is substantially free, preferably free of non-ionic surfactant. In some embodiments, the block composition is substantially free from water.

In another embodiment, the present invention is directed to a cageless self-adhesive in-the-bowl block composition consisting essentially of (a) from about 15% to about 45% by weight of an inorganic sodium salt; (b) from about 45% to about 75% by weight of an anionic surfactant selected from the group consisting of sodium dodecyl benzene sulfonate, sodium lauryl sulfate and mixtures thereof; (c) from about 0.5% to about 3% by weight of an adhesion promoter; (d) from about 0.5% to about 3% of a chelating agent, (e) from about 0.1% to about 1.0% by weight of an antioxidant; and wherein said composition is in the form of a hexagonal shape block wrapped and sealed by a water-soluble film and is capable of adhering to sanitary object when applied directly. In certain embodiments, the water-soluble film has a thickness of about 35, and most preferably about 30 microns. In some embodiments, the thickness of the water-soluble film may vary at the top, sides or bottom part of the block. In some embodiments, the sodium salt is sodium sulfate; anionic surfactant consists of a combination of sodium dodecybenzene sulfonate and sodium lauryl sulfate, the adhesion promoter is n-methyl-alkyl glucamide, and the antioxidant is sodium phytate.

In another aspect, the present invention is directed to a method of cleaning a sanitary appliance and hard surfaces comprising creating a moist surface on the wall of a sanitary appliance, placing a self-adhesive block composition according to the first aspect of the present invention, to the walls of a sanitary applicant by directly applying the composition to the sanitary appliance, triggering a flushing operation to release the ingredients of the block composition, wherein the block composition stays adhered to the sanitary object for at least a period of 7, 10, 14, 21, 28, up to 60 days. In certain embodiments, the composition can stay adhered to the object for at least a period of up to 7, 10, 14, 21, 28, or 60 days.

In some embodiments, the anionic surfactants are present in the composition in an amount of 15-75% by weight particularly preferably 45-70% by weight, in particular about 50% to about 70% by weight. In certain embodiments, the anionic surfactant is selected from the group consisting of sodium dodecylbenzene sulfonate, sodium alpha olefin sulfonate, sodium dodecyl sulfate, sodium laurate sulfate, sodium lauryl sulfate (C₁₀-C₁₆), sodium stearate, and magnesium laureth sulfate or any combinations thereof. In one embodiment, the anionic surfactant is sodium dodecylbenzene sulfonate available under the tradename Marlon ARL/Ufaryl and/or sodium lauryl sulfate (C₁₀-C₁₆).

In some embodiments, the non-ionic surfactant may optionally be present in the compositions in amounts ranging from about 0% to about 20% weight percent. In other embodiments, the concentration of non-ionic surfactants ranges from about 0.5% to about 10% weight. In other embodiments, the concentration of the non-ionic surfactant ranges from 2% to about 4.0% by weight. In other embodiments, the concentration of the non-ionic surfactant ranges from 1% to about 3.0% by weight. In some embodiments, the compositions of the present invention contain one non-ionic surfactant in amounts up to 2.5% by weight of the composition. In certain embodiments, the composition are further substantially free of any bleach material and any other non-ionic surfactant.

In another aspect of the present invention, anionic surfactant, chelating agent, adhesion promoter and the antioxidant are present in a ratio of 125 to 375:2.5 to 15:2.5 to 15:0.5 to 1.5 respectively on a weight basis. In some embodiments, the ratio of chelating agent, adhesion promoter and the antioxidant are 175 to 350:9 to 11:7 to 9:0.8 to 1.2 respectively. In preferred embodiments, the ratio of the anionic surfactant, chelating agent, the adhesion promoter and the antioxidant is 350:10:7.5:1, respectively on the weight basis, for achieving a composition adherence that stays on the sanitary object for at least up to 7, 10, 14, 21, 28, 60 days, when subject to multiple flushing operation such as 8, 10, 12 or 15 flushes a day.

In some embodiments, the chelating agent, adhesion promoter and the antioxidant are present in a ratio of 2.5 to 15:2.5 to 15:0.5 to 1.5 respectively on a weight basis and may preferably be present in a ratio of 9 to 11:7 to 9:0.8 to 1.2 respectively. In preferred embodiments, the ratio of chelating agent, adhesion promoter and the antioxidant in the present composition is 10:7.5:1, respectively on a weight basis for achieving a composition adherence that stays on the sanitary object for at least up to 7, 10, 14, 21, 28, 60 days, when subject to flushing operation.

In other embodiments, the composition has a pH of between 4 and 10, preferably between 7 and 9, more preferably between 7.6 and 8.6, measured at 20° C. In another embodiment, the composition has a pH of between 3 and 9, preferably between 6 and 9, more preferably between 7.5 and 8.5, measured at 20° C.

In some embodiments, the composition of the present invention contains less than 5% water content, preferably, less than 3.5% water content. In some embodiments, the cleaning composition is substantially free of water.

In other embodiments, the composition would maintain its stability and stickiness/adhesiveness for up to 105 weeks at room temperature and room relative humidity. In other embodiments, the composition maintains its stability and adhesiveness for at least 2 days up to 12 weeks under accelerated conditions at 40 (±2° C.) at 75 (±0.5) % Relative Humidity. In preferred embodiments, the composition maintains it semi-solid malleable form for, 1, 2, 3, 4, 5, 6, 7, 9, 10, 12 weeks under accelerated conditions.

### Surfactants

In certain embodiments, the compositions of the present invention contain at least one anionic surfactant, but free of any other surfactants. In other embodiments, the composition may include and at least one non-ionic surfactant, but in amounts less than 20%, 10%, 15%, 5%, 2.5% or 0.5% by weight of the composition. In some embodiments, the composition of the present invention contains at least one anionic surfactant and at least one non-ionic surfactant but free of any other surfactant source.

The anionic surfactants used in the present invention include sulfonate or sulfate type of carboxylate type compounds. Suitable surfactants of the sulfonate type here are preferably C₉₋₁₃-alkylbenzenesulfonates, such as dodecylbenzene sulfonate salts, olefin sulfonates, i.e. mixtures of alkane- and hydroxy alkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Other suitable anionic surfactants include alkanesulfonates which are obtained from C₁₂₋₁₈-alkanes, or ester sulfonates such as α-sulfonated methyl esters of hydrogenated coconut, palm kernel or tallow fatty acids or combinations thereof. Among all such compounds, the alkali metal salts of the sulfonate, in particular the sodium salts are preferred.

Other anionic surfactants are sulfated fatty acid glycerol esters. Fatty acid glycerol esters are to be understood as meaning the mono-, di- and triesters, and mixtures thereof, as are obtained during production by esterification of a monoglycerol with 1 to 3 mol of fatty acid or during transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

other suitable anionic surfactants are also the salts of alkylsulfosuccinic acid, which are also referred to as sulfosuccinates or as sulfosuccinic acid esters and represent the monoesters and/or diesters of sulfo-succinic acid with alcohols, preferably fatty alcohols and in particular ethoxylated fatty alcohols. Preferred sulfosuccinates contain C₈₋₁₈-fatty alcohol radicals or mixtures of these. Particularly preferred sulfo-succinates contain a fatty alcohol radical derived from ethoxylated fatty alcohols which, when viewed per se, represent nonionic surfactants (for description see below). In this connection, particular preference is in turn given to sulfosuccinates whose fatty alcohol radicals are derived from ethoxylated fatty alcohols with a narrowed homologue distribution. It is also likewise possible to use alk(en)ylsuccinic acid having preferably 8 to 18 carbon atoms in the alk(en)yl chain or salts thereof.

According to the invention, the anionic surfactants used are preferably alkylbenzene sulfonates and/or alkanesulfonates, fatty alcohol ether sulfates and/or alkyl sulfates.

The anionic surfactants can be present in the form of their sodium, potassium or ammonium salts, and as soluble salts of organic bases, such as mono-, di- or triethanolamine. The anionic surfactants are preferably present in the form of their sodium or potassium salts, in particular in the form of the sodium salts.

The anionic surfactants are preferably present in the composition in an amount of 10-80% by weight, 15-75% by weight, preferably 45%-70%% by weight, in particular about 50% 72.5% by weight. In certain embodiments, the anionic surfactant is selected from the group consisting of sodium dodecylbenzene sulfonate, sodium alpha olefin sulfonate, sodium dodecyl sulfate, sodium laurate sulfate, sodium lauryl sulfate, sodium stearate, and magnesium laureth sulfate or any combinations thereof. In one embodiment, the anionic surfactant is sodium dodecylbenzene sulfonate available under the tradename Marlon ARL/Ufaryl.

The non-ionic surfactants include an extensive list of chemical compounds which are generally selected from the group consisting of long-chain alcohols (from about 10 to about 20 carbon atoms), such as polyoxyethylene derivatives of fatty acids, starch alkanols of fatty acids, alkyl polyglucosides (APG), natural and/or synthetic ethoxylated alcohols, amine oxide, castor oil based ethoxylate, fatty alcohol ethoxylates, sorbitol ester ethoxylate and polyol esters. Depending on the concentration of such non-ionic surfactants, they may or may not act as an adhesive promoter.

In some embodiments, the non-ionic surfactant may be an ethoxylated or ethoxylated and propoxylated fatty acid alkyl esters, preferably having 1 to 4 carbon atoms in the alkyl chain, in particular fatty acid methyl esters. In some embodiments, the non-ionic surfactants may be a block copolymer based on a polymeric ethoxy/propoxy units (i.e. Pluronics® such as Pluronic® F108, Pluronic® F88 available by BASF) or a polyethylene glycol (PEG, ex. Polyglkcol® 6000S).

In some embodiments, the non-ionic surfactant includes a difunctional block copolymer terminating surfactant terminating in primary hydroxyl groups. In other embodiments, the non-ionic surfactant may be a polyglucoside such as alkyl polyglucoside (i.e. Glucopon®).

Suitable nonionic surfactants of the amine oxide type may include, for example N-cocoalkyl-N,N-dimethylamine oxide, N-tallow-alkyl-N,N-dihydroxy ethylamine oxide and of the fatty acid alkanolamide. The amount of these nonionic surfactants is preferably not more than that—of the ethoxylated fatty alcohols, in particular not more than half thereof.

In some embodiments, the total concentration of the non-ionic surfactant ranges from about 0% to about 20% weight percent, preferably in ranges between 0.1% to about 5%, more preferably in ranges between 1% to about 2%. In some embodiments, the composition is substantially free of any non-ionic surfactants. In some embodiments, except for the adhesive agent that may be characterized as a non-ionic moiety, the composition is free of any non-ionic surfactants. In other embodiments, the concentration of non-ionic surfactants is less than 2.5%, 2.0%, 1.5%, 1.0%, 0.5% and 0.25%. In some embodiments, the anionic surfactant is the sole source of surfactant.

In some embodiments, in addition to an anionic or a non-ionic surfactant, the surfactant system may optionally include cationic and/or amphoteric surfactants and mixtures thereof. In general, useful surfactants may be one or more of those described for example in Mccutcheon's Functional Materials, Vol. 2, 1998; Kirk-Othmer, Encyclopedia of Chemical Technology, 4th Ed., Vol. 23, pp. 481-541 (1997), the contents of which are herein incorporated by reference.

### Adhesion Facilitators

### a) Adhesion Promoters

Adhesion promoters are compounds that, in the presence of water, causes the agent to adhere to the surface. In general, such compounds form network-like structures which give the compositions of the present invention the required dimensional stability and adhereability to withstand its integrity, even under the action of strong forces due to flush water. The molecules of the adhesion promoter are typically longer-chain or long-chain, essentially stretched molecules which are at least partially hydrophilic having at least one hydrophilic radical or one hydrophilic group which interacts with water. Therefore, the adhesion promoters are typically organic molecules with one hydrophilic end and one hydrophobic end.

A large class of adhesion promoters is formed by the nonionic moieties and the nonionic emulsifiers. Such ingredients are independent and viewed separate as any other non-ionic moieties that may act as non-ionic surfactant. Even though the adhesion promoters may structurally be viewed as a non-ionic surfactant, it does not act as a surfactant due to its low concentrations in the instantly described compositions.

In at least some embodiments, the adhesion promoters that can be used in the present compositions include alkoxylated non-ionic surfactants, preferably ethoxylated and/or propoxylated, particularly preferably ethoxylated, primary linear alcohols, in particular fatty alcohols, and/or fatty acids having preferably 8 to 22, particularly preferably 12 to 22, carbon atoms and on average 5 to 120 mol of ethylene oxide (EO) and/or 1 to 5 mol of propylene oxide (PO) per mole of alcohol, in which the alcohol radical may be linear or preferably 2-methyl branched, or may contain linear and methyl-branched radicals in a mixture, as are usually present in oxo alcohol radicals. Alcohol ethoxylates with linear radicals from alcohols of native origin having 12 to 22 carbon atoms, for example from coconut, palm, tallow fatty or oleyl alcohol, and on average 20 to 100, in particular 20 to 80, EO per mole of alcohol, in particular, are preferred. Preferred ethoxylated alcohols include, for example, C₁₂₋₁₄-alcohols and/or tallow fatty alcohols having 30, 40, 50 or 60 EQ units and mixtures of these. The stated degrees of ethoxylation are, if appropriate, statistical averages, which may be an integer or a fraction for a specific product. Preferred alcohol ethoxylates have a narrowed homologue distribution (narrow range ethoxylates, NRE).

As the number of alkoxy groups decreases, the adhesion promoter becomes more lipophilic, as a result of which, for example, the solubility of perfume and thus the intensity of the fragrance can be increased.

In some embodiments, the adhesion promoter may be a non-ionic moeity derived from an ethoxylated or ethoxylated and propoxylated fatty acid alkyl esters, preferably having 1 to 4 carbon atoms in the alkyl chain, in particular fatty acid methyl esters. In some embodiments, the non-ionic surfactants may be a block copolymer based on a polymeric ethoxy/propoxy units (i.e. Pluronics® such as Pluronic® F108, Pluronic® F88 available by BASF) or a polyethylene glycol (PEG). In such embodiments, the concentration of the adhesion promoter is less than 2.5%, preferably less than 1.5% and most preferably about 1.0% to about 1.5% by weight of the composition.

Sugar surfactants are non-ionic surfactants that are also suitable adhesion promoters for the compositions according to the present invention. Sugar-based surfactants can be derived from the sugar raw materials occurring in the form of monomeric (such as glucose, fructose, sorbitol), dimeric (such as sucrose, lactose) or polymeric (such as starch, cellulose, pectin, chitin, polysaccharides, dextrins) compounds. At the same time, these materials may constitute a hydrophilic head in the molecule of obtained surface active agent which is linked glycosidically with the alkyl moiety of the fatty alcohol or which is linked with the rest of the fatty acid by the ester, amine or amide bond. The type of chemical bond existing between the hydrophilic and hydrophobic parts of the surfactant molecule has an effect on its properties. The presence of amide group in the molecule reduces the solubility of the surfactant in water and gives a stable connection between the head and tail of the surfactant characterizing high resistance to acidic and basic hydrolysis. Yet, the amide bond is easily degraded. The ether groups form a strong bond not easily degraded in nature in contrast to the ester groups which form a weaker bond, useful and flexible which can be easily hydrolyzed. The preferred adhesion promotors according to the present invention are sugar non-ionic surfactants selected from the group consisting of alkyl polyglucoside, fatty acid glucamide, or mixtures thereof. To that end, the concentration of such adhesion promoter ranges between 1% to about 2.5%, preferably about 1.5% by weight of the composition.

In some embodiments, the adhesion promoters may be used in the amounts ranging from about 0.5% to about 5% by weight, preferably between 1% to about 3%. In some embodiments, the adhesion promotor is a sugar surfactant derived from interaction of glucose and natural oils. In some embodiments, the adhesion promoter is an n-methyl-alkyl glucaide, a capryloyl/caproyl methyl glucamide (i.e.—Glucitol, 1-deoxy-1-(methylamino)-, N—[C8-10 (acyl] derivatives) in amount of 1.5 or 2% by weight.

Another class of the non-water-soluble adhesion promoters from the group of polyalkylene derivatives includes polyalkylene chains with randomly distributed functional groups. The polyalkylene chains are preferably polybutadiene, polyisopropylene and polypropylene chains. The functional groups randomly distributed over the polyalkylene chains are preferably reactive groups, in particular from the group of anhydrides, thiols, epoxides or primary amines. Particular preference is given to polymers with maleic anhydride groups bonded randomly to the polybutadiene chain. The particularly preferred maleic anhydride adduct onto 1,4-cis-polybutadiene is available from Degussa under the name Polyvest®.

Other suitable adhesion promoters include polystyrene derivatives which are preferably crosslinked polystyrene derivatives dissolved in mineral oil, in particular alkylene styrene copolymers, such as, for example, hydrogenated butylene/ethylene/styrene copolymers and hydrogenated ethylene/propylene/styrene copolymers, which are available for example from Penreco under the trade name Versagel® M750 or Versagel M1600.

Furthermore, as non-water-soluble adhesion promoters it is possible to use silicone systems, for example from the group of construction silicones eliminating acetic acid (acetate system), or based on amine/aminoxy systems, oxime systems, benzamide systems and alkoxy systems, provided these forms a homogeneous, stable mixtures.

Other suitable adhesion promoters may include-water-soluble olefin homopolymers and copolymers of two and more olefins. These compounds include, for example, the polybutadiene rubbers, the styrene-butadiene block polymers and copolymers, and the polyisopropenes. As water-soluble adhesion promoters it is also possible to use copolymers from the group of monoalkyl esters of poly(methyl vinyl ethers/carboxylic anhydrides, which are commercially available, for example, under the trade name Gantrez from ISP.

Finally, a further class of the water-soluble adhesion promoters are the polyalkyleneimines, i.e. polymeric amines or polymers which comprises polyimine groups. The class of polyimines includes in particular the homopolymeric polyalkyleneimines of the general formula —(R—NH)ₙ— where R is an alkyl or an alkyl derivative, n=10-105 and two- or three-dimensional crosslinking via the nitrogen function, depending on the degree of alkylation or arylation on the nitrogen. A preferred class of the polyalkyleneimines are available for example from BASF under the trade name Lupasol with different molecular masses and degrees of crosslinking (ex. Lupasol® PS and FG).

### b) Adhesive Water-Soluble External Film

In yet another aspect of the present invention, the adhesion can also be facilitated by an adhesive agent that partially or completely covers the external surface of the composition. In some embodiments, such adhesive agents may be a water-soluble polymeric film that creates a homogenous layer of external film surrounding the composition free of evident roughness, providing contact with the surface of the sanitary object. In at least one embodiment according to this aspect of the present invention, the sanitary composition may or may not contain an adhesive promoter.

In some embodiments, the composition contains an adhesive promoter dispersed therein and wrapped with a water-soluble polymeric film that facilitates adhesion to a moist wall. In certain embodiments, the water-soluble polymeric film may contain poly (vinyl alcohol) (“PVOH”), plant based polysaccharide (Decomer), Agar, plant starch, carboxymethylcellulose (CMC) and hydroxy carboxymethyl cellulose (HPMC), natural starch and vegetable oil, hyaluronic acid, PEG oxides, casein and casinates, PEO based polymers, alginates, cellulose ether, or other water-soluble polymers that is suitable for wrapping, laminating or surrounding the compositions according to the present invention. In some embodiments, the polymeric film is any of the PVOH, a plant based polysaccharide (Decomer), a plant starch, CMC and HPMC films, natural starch and vegetable oil, hyaluronic acid, or alginate. In preferred embodiments, the polymeric film is PVOH which may be partially or fully alcoholized or hydrolyzed. For example, it may be from 10 to 100%, preferably 50 to 95%, more preferably about 80-90%, alcoholized or hydrolyzed, polyvinyl acetate.

In some embodiments, the PVOH may be converted to a sheet containing a pocket or thermoformed into a molding, which is able to retain the compositions according to the present invention. A second sheet of a water-soluble polymer such as PVOH or a cellulose ether may then be secured over the top of the solid composition, pressed, stamped and sealed to form the closure parts for the wrapped sanitary block composition according to the present invention. Those of ordinary skill in the art would understand that other methods of stamping and sealing the films may be employed for example infra-red, radio frequency, ultrasonic, laser, solvent, vibration or spin welding.

In some embodiments, the water-soluble film according to the present invention may also include poly vinyl acetate, or PVOH-co vinyl acetate, or a biodegradable plastic such as for example the film obtained from corn starch, cellulose and/or composed of mono- or oligosaccharide.

PVOH is a synthetic resin, generally produced by using ethylene gas and acetic acid to produce vinyl acetate. When acetate groups have been hydrolyzed to alcohol groups, PVOH is respectively obtained. Water solubility of PVOH depends on the degree of hydrolysis and the degree of polymerization. Hydroxyl groups cause PVOH to have a high affinity to water and increase water solubility. After the block composition of the present invention wrapped and sealed with the water-soluble film, it is ready to be placed in contact with a slightly-moist surface of the sanitary appliance to be treated. Adhesion of the composition of the block unit to the moist surface is facilitated before the water-soluble film is completely solubilized. The strength of adhesion may depend on the thickness of the water-soluble film surrounding the composition.

The water-soluble film preferably has a thickness of from 10 micron to 100 microns, and preferably from 25 to 60 micron, and still more preferably from 30 to 50 microns, and most preferably 30 microns. In certain embodiments, the thickness of the film may vary in different sides of the block, so that the side that is adhered to the sanitary appliance has less thickness than other sides. In some embodiments, the thickness of the water-soluble film at each side of the block may range from 10 to 50 microns independently. In certain embodiment according to the present invention, the block composition may be wrapped completely with a water-soluble film made of PVOH, having a thickness ranging between 15 but less than 40 microns. In some embodiments, the thickness of the PVOH film surrounding the composition may vary so that thickness of the top part of the unit is less than the thickness of the bottom part of the unit.

### Antioxidants

In some embodiments, anti-oxidants are added to reduce or prevent the effects of oxidation processes. The unsaturated fatty acids elements of the sanitary components are highly susceptible to oxidation and to that end, antioxidants limit the undesired effects caused by such oxidation process. The undesired effects of oxidation can manifest themselves during storage or during use of the compositions of the present invention and reduce the efficacy and stability of such products. Examples of the unwanted effects of oxidation processes include but are not limited to: discoloration, malodor, perfume degradation, deactivation of ingredients such as organic surfactants, biocidal and germ eliminating compounds, bleach, enzymes and change in properties of the adhesive agents based materials.

Accordingly, in some embodiments, the compositions made according to the invention may comprise antioxidant or mixtures thereof. Suitable antioxidants for incorporation into the present invention include but are not limited to sodium phytate, butyl hydroxy toluene (BHT), hydroquinone, ditert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-proyl-gallate, citric acid, ascorbic acid, tartaric acid, adipic acid and sorbic acid, or amines like lecithin, or amino acids like glutamine, methionine and cysteine, or esters like ascorbil palmitate, ascorbil stearate and triethylcitrate, pentaerythrityl tetra-di-t-butyl hydroxyhydrocinnamate (Tinogard®), trihydroxy-flavanone, trihydroxy-methoxyflavanone, ferrolic acid, caffeic acid, Vitamins A and E, and any mixtures thereof or even a multi-ingredient mixture such as orange wax, also known as orange peel wax.

In some embodiments, the antioxidant may be present in amounts up to 10% and preferably from 0.01% to 10%, 0.01% to 5%, or 0.1% to about 0.5% by weight of the total composition. In certain embodiments, the antioxidant is sodium phytate at amount of about 0.2%.

### Other Ingredients

Filler ingredients according to the present invention are used to regulate the consistency of the composition. Among suitable fillers are those that can adjust the viscosity and/or the flushability of the agent and to achieve the desired deodorization or coloring of the agent. In certain embodiments, the fillers of choice include alkali or alkali metal salts, particularly sodium and calcium salts that can improve the form and consistency of the composition. Preferred fillers according to the present invention are selected from the group consisting of sodium sulfate, sodium chloride, sodium carbonate, sodium bicarbonate, sodium polyphosphate sodium sulfate, sodium borate, sodium silicate, calcium sulfate, and calcium carbonate. In some embodiments, the amount of such filler is from about 10% to about 60%; or about 12.5% to about 45%; or about 15% to about 42.5% by weight of the composition.

In some embodiments, sodium sulfate is the preferred sodium salt to be added into the composition to improve consistency and the dissolution rate. In one embodiment, the filler is sodium sulfate in amount up to about 45% by weight, preferably ranging from about 12.5% to 45% by weight, most preferably between 15% to about 25% by weight.

Chelating agents are molecules capable of binding the metal ions to prevent the metal ions from interfering with the action of the other detersive ingredients of a cleaning composition. In addition, by removing metallic ions, the skilled artisan would observe an improvement of the foaming capabilities of the composition. In some embodiments, the composition of the present invention contains at least one chelating agent. Suitable chelating agents are, for example, salts or derivatives of citrate, amino carboxylic acid, condensed phosphate, phosphonate, and polyacrylate. In some embodiments, the chelating agent may be present in the compositions disclosed herein at from about 0.05% to about 10% by weight, about 0.1% to about 5% by weight, about 0.5% to about 3.0% by weight. In other embodiments, the concentration of the chelating agent is about 2% by weight. In some embodiments, the chelating agent is trisodium citrate.

Besides the constituents according to the invention, the compositions of the present invention can comprise further customary constituents such as a dispersant, a thickener, perfume substances, disinfectants, dye or colorant, bitterness flavorant (bittering agent), hydrotropes, anticorrosion agents, opacifiers, brighteners, abrasives such as silica, kaolin, talc; an absorbent; preservatives, such as, for example, isothiazolone derivative, or foam stabilizers, such as coconut fatty acid amidopropylbetaine or coconut fatty acid amidopropyldimethylamine oxide, coconut fatty acid mono/diethanolamide or alkyl polyether glycerol ether sulfates, substances which dissolve limescale or urine scale in particular acids, a biocidal combinations having any one or more of the antiviral, antimicrobial, antibacterial, antifungal, antiprotozoal, antiarcheal, and/or antiparasitic activities that may be selected from quaternary ammonium-based biocides.

The biocidal ingredients according to the present invention are essentially bleach free. Examples of such biocides include quaternary ammonium derivatives, n-alkyl dimethyl benzyl ammonium chloride, n-alkyl, dimethyl ethyl benyl ammonium chloride, dodecyl dimethyl ammonium chlorides (DDAC), cetyl trimethyl ammonium chloride (CTAC), benzalkonium chloride (BAC), or any mixtures thereof. In certain embodiments, the biocide material includes n-alkyl dimethyl benzyl ammonium chloride, n-alkyl, dimethyl ethyl benyl ammonium chloride, either alone or in combination together as provided under the BTC® 2125M series by Stepan. In some embodiments, the total concentration of the biocides in the present composition is in the range of between 1% to about 20% by weight. In other embodiments, the biocide system may be present in the range of between 4% to about 10% by weight. In certain embodiments, however, the compositions according to the present invention are substantially free of bleach and any other sources of non-ionic surfactants.

The additional perfume substances optionally present are those customary from the prior art or available commercially such as Marine 20 ITB T12050887. Other examples which may be mentioned are mixtures of natural and synthetic fragrances. Natural fragrances are extracts from flowers (lily, lavender, rose, jasmine, neroli, ylang-ylang), stems and leaves (geranium, patchouli, petitgrain), fruits (anise, coriander, caraway, juniper), fruit peels (bergamot, lemon, oranges), roots (maize, angelica, celery, cardamom, costus, iris, calmus), woods (pinewood, sandalwood, guaiac wood, cedar wood, rosewood), herbs and grasses (tarragon, lemon grass, sage, thyme), needles and branches (spruce, fir, pine, dwarf-pine), resins and balsams (galbanum, elemi, benzoin, myrrh, olibanum, opoponax). Also suitable are animal raw materials, such as, for example, civet and castoreum. Typical synthetic fragrance compounds are products of the ester, ether, aldehyde, ketone, alcohol and hydrocarbon type. Fragrance compounds of the ester type are, for example, benzyl acetate, phenoxyethyl isobutyrate, p-tert-butyl cyclohexylacetate, linalyl acetate, dimethyl benzyl carbonyl acetate, phenylethyl acetate, linalyl benzoate, benzyl formate, ethylmethylphenyl glycinate, allyl cyclohexylpropionate, styrallyl propionate and benzyl salicylate. The ethers include, for example, benzyl ethyl ether, the aldehydes include, for example, the linear alkanols having 8 to 18 carbon atoms, citral, citronellal, citronellyloxyacetaldehyde, cylamenaldehyde, hydroxycitronellal, lilial and bourgeonal, the ketones include, for example, the ionones, α-isomethylionone and methyl cedryl ketone, the terpene alcohols include menthol, anethol, citronellol, eugenol, isoeugenol, geraniol, linalool, nerol, phenylethyl alcohol, tetrahydromyrcenol and terpineol, and the hydrocarbons include primarily the terpenes and balsams. However, preference is given to using mixtures of different fragrances which together produce a pleasing scent note.

Essential oils of lower volatility, which are mostly used as aroma components, are also suitable as perfume oils, for example sage oil, chamomile oil, oil of cloves, melissa oil, mint oil, cinnamon leaf oil, linden blossom oil, juniper berry oil, vetiver oil, oliban oil, galbanum oil, labolanum oil and lavandin oil. Preference is given to using bergamot oil, dihydromyrcenol, lilial, lyral, citronellol, phenylethyl alcohol, α-hexylcinnamaldehyde, geraniol, benzyl acetone, cyclamenaldehyde, linalool, boisambrene forte, ambroxan, indole, hedione, sandelice, lemon oil, mandarin oil, orange oil, allyl amyl glycolate, cyclovertal, lavandin oil, clary sage oil, β-damascone, geranium oil bourbon, cyclohexyl salicylate, vertofix coeur, iso-E-super, fixolide NP, evernyl, iraldein gamma, phenylacetic acid, geranyl acetate, benzyl acetate, rose oxide, romillat, irotyl and floramat, alone or in mixtures. The amounts of such fragrances is dependent on the desired scent intensity and is preferably in the range from 2-15% by weight, particularly preferably from 5-10% by weight.

Suitable dyes that may be used in this invention include, but are not limited to Hostaperm Blue A4R, Sanolin Blue EHRL, Sanolin Blue NBL, Sanolin Lave Blue A liq, Sanolin Tartrazine X 90 and Sanolin Quinoline Yellow 70 (Clariant) or the like.

The present invention is also directed to a method of cleaning a sanitary appliance and hard surfaces comprising the steps of (a) creating a moist surface on the wall of a sanitary appliance, (b) placing a self-adhesive block composition according to the first aspect of the present invention, to the walls of a sanitary applicant by directly applying the composition to the sanitary appliance, and (c) triggering a flushing operation to release the ingredients of the block composition. In certain embodiments, the block composition stays adhered to the sanitary object for at least a period of up to 7, 10, 14, 21, 28, or 60 days. In some embodiments, the flushing operation is triggered up to 15 times a day, but preferably 5, 6, 7 or 8 times a day.

In some embodiments, the method further includes the step of applying water to remove undesirable scaling and odor in the area of interest. In certain embodiments, the sanitary appliance is of material selected from the group consisting of bricks, ceramic, cement, crystal, diamond, glass, latex, marble, metallic, pebbles, porcelain, polymeric and quarry tiles, and natural stone.

In some embodiments, and for purposes of enhancing fragrance experience, the methods described herein can also be used in the bathroom by applying the composition in the area of interest and perfuming the area by allowing the fragrance to be released from the composition.

The present invention also provides for blister pack kits that comprise at least one cup shape cavity for housing the unit block compositions according to the present invention. The blister pack may contain a plurality of cup shape cavities each of which are sealed with a single or dual sealing layer of a polymeric film made of such polymers as polyethylene terephthalate, polyester or polyvinyl chloride.

The present invention is also directed to methods of manufacturing the block units of the present invention as described below in the following examples.

### EXAMPLES

A preferred embodiment of the first aspect of the present invention is generally directed to solid, semi-solid or malleable block compositions for direct application to a sanitary appliance, which has a prolong duration of adherence to the sanitary appliance. Suitable embodiments are provided herein in the following Examples:

### Example 1

At least one embodiment of such composition has the following components:

TABLE 1

| | % W/W in the | |
|---|---|---|
| Ingredients | Composition | Purity |
| Filler - Sodium Salt | 15 to 45 | >99%, preferably 100% |
| Anionic Surfactant | 25 to 75 | >99%, preferably 100% |
| Chelating Agent | 0.15 to 5 | >99%, preferably 100% |
| Adhesion promoter | 0.5% to 5 | >99.5%, preferably 100% |
| Dye | 0.15 to 0.35 | >99.5%, preferably 100% |
| Fragrance | 1 to 6 | >99.5%, preferably 100% |
| Anti-Oxidant | 0.1 to 1 | >99.5%, preferably 100% |
| | 100 | |

Table 2 below provides another preferred example of the composition of the present invention (see Table 3, Ex 1):

TABLE 2

| Function | Ingredients | % W/W |
|---|---|---|
| Filler | SODIUM SULFATE | 40.290 |
| Anionic Surfactant | Sodium Dodecylbenzene | 50.000 |
| | Sulfonate | |
| Chelating Agent | TRISODIUM CITRATE | 2.000 |
| Adhesion Promoter | n-Methyl-Alkyl Glucamide* | 1.500 |
| Dye | HOSTAPERM BLUE A4R | 0.010 |
| Fragrance | MARINE 20 ITB T12050887 | 6.000 |
| Antioxidant | Sodium Phytate** | 0.2 |

*Glucopure ® wet from Clariant.
**Dermofeel PA-3 from Evonik.

Compositions according to the present invention were prepared by mixing the various components as set forth in Table 3, in a laboratory mixer at ambient temperature, leaving it to mix for about up to 10 minutes to form a dry powder premix blend. A liquid dye premix is then added to the blend and mixed for suitable time of up to about 15 min to obtain a homogeneous, plastic and modellable extrudable mixture in a dough-like texture. The mixture is subsequently moved through an extruder, then cut in appropriate shapes and cylinders and placed on a tray. The extruded and the semi-solid malleable cylindrical form are then transferred to an assembly system for stamping/wrapping.

At the assembly system, the water-soluble film such as PVOH (having a thickness about 30-35 microns) is first unwinded and placed on top of the stamping mold containing the shaped cavity and subsequently thermoformed using a suction and a heating device. Then the semi-solid malleable composition including an anionic surfactant, an adhesion promotor, a chelating agent and the filler, and optionally the dye and the fragrance, is placed into each hexagonal shaped cavity on the PVOH film which is respectfully unwinded on top of each cavity. A second PVOH film may be placed on top of the assembly and subsequently stamped, sealed and cut to produce the unit dose self-adhesive and cageless compositions block units having the weight of about 10 g.

The compositions E-1-E5 provided in the Table below were made according to the process steps described above.

TABLE 3
Compositions and Comparative results

| Component (% W/W)* | E-1 | E-2 | E-3 | E-4 | E-5 |
|---|---|---|---|---|---|
| Sodium Sulfate | 40 | 44 | 60 | 50 | 30 |
| SDBS | 50 | 20 | 15 | 40 | 50 |
| Alpha Olefin Sulfonate | — | 10 | 10 | — | — |
| Sodium Bicarbonate | — | 5 | — | — | 3.6 |
| Dried Silica | — | — | 5 | — | — |
| Fatty Alcohol 25 EO | — | 3 | — | — | 3 |
| Citric Acid | — | 9 | — | — | 6.5 |
| Microcrystalline Cellulose | | 2 | — | — | 2 |
| Trisodium Citrate | 2 | — | 5 | 2 | 2 |
| n-methyl-alkyl glucamide | 1.50 | — | — | 3 | — |
| Sodium Phytate | 0.2 | — | — | — | — |
| Dye | 0.02 | 0.01 | 0.01 | 0.01 | 0.01 |
| Fragrance | 6.00 | 6.00 | 6.00 | 6.00 | 6.00 |

| | |
|---|---|
| Total | 100 |

*+/−1%

The following attributes were evaluated to assess the suitability of the compositions of Table 3 for their intended purpose:
1. Stickiness.—Assess the level of stickiness of a block composition.
2. Hardness and stampability—Assess the level of hardness of a block composition and its stampability to withstand the press.
3. Lifespan test—Measuring the duration that the block of the present invention stays adhered to the wall of the sanitary appliance simulating reality of such product's use when the block is subjected to 12 flush operations per day distributed at irregular intervals. The test is continued until complete consumption of the product that determines the duration of use. The requirement to pass this test is staying adhered to the wall of the sanitary appliance for at least 14 days.
4. Stability—Performing an accelerated stability corresponding to the 6 month shelf life, at storage conditions 40° C. for 12 weeks at 75% RH. Stability and dimensions are checked by assessing visual aspect and measuring product's discoloration and dimensions.
5. Foaming—Visually measuring the extent of foaming achieved and measuring the duration of the presence of foam.
6. Extrudability—Assessing whether the composition blend has the texture and consistency to undergo extrusion.

Comparing results of the E-1 against E 2-5 indicates that the addition of anti-oxidants to the anionic surfactant, adhesion promoter and the chelating agent at the ratios according to the present invention, increased the stability, adherence and the stamp ability of the composition for its intended purpose. The block composition of E-1 provided the superior results by meeting all suitability criteria as compared to all other block compositions of Table 3. E-2 failed the suitability as it did not meet the lifespan criteria and lasted only 60 flush operations. E3 blend stayed as a powder mixture and did not form a dough-like texture. As such, it was not suitable for extrusion. This example failed all criteria. The composition of E-4 composition had a higher concentration of adhesion promoter, but the variation in amount of adhesion promoter did not produce the desired stability, adhesion or the hardness. The block also failed the stampability criteria. The composition of E-5 failed the lifespan test as it failed to stay on the sanitary object no more than 7 days. Considering the totality of evidence, the composition of E-1, contained the superior blend and ratios of the ingredients used therein to meet all suitability criteria.

### Example 2

Compositions of E-6 was manufactured according to the process described in Example 1 using the ingredients provided in Table 4 below. E-7 compositions was manufactured by adding the ingredients provided in Table 4 below, into container and mixed together for 30 minutes, at the ambient temperature until a homogenous, plastic and malleable mixture was obtained. E-6 and E-7 were further investigated for their respective stability.

TABLE 4

| | | E-6 | E-7 |
|---|---|---|---|
| Function | Chemical ingredient | W/W % | W/W % |
| Filler | Anhydrous NA sulfate | 16.28 | 38% |
| anionic | SDBS | 50.00 | — |
| surfactant | | | |
| anionic | Sodium lauryl sulfate | 20.00 | |
| surfactant | (C10-C16) | | |
| Anionic | Alkyl sulfate Texapon ® | — | 2% |
| surfactant | V95 | | |
| Non-ionic | Megital CS25 ® (Cethearet | — | 39% |
| Surfactant | 25)* | | |
| Non-ionic | Comperlan 100** | — | 8% |
| surfactant | | | |
| Non-ionic | Glucopon ® 50 g*** | — | 5% |
| surfactant | | | |
| organic acid | Na citrate | 2.00 | — |
| Adhesive agent | n-methyl-alkyl glucamide | 1.50 | 1% |
| Foamer | Deriphat ®160 c | — | 2% |
| | (cognis)**** | | |
| fragrance | Marine 21 M2 ITB | 10.00 | 5% |
| | T12057981 | | |
| Dye | HOSTAPERM BLUE | 0.0070 | |
| | A4R | | |
| antioxidant | sodium Phytate | 0.20 | — |
| bittering agent | Denatonium benzoate | 0.0100 | — |
| External film | PVOH | Wrapped and | Wrapped and |
| | | sealed | sealed |

*C16-18 ethoxylated alcohol.
**Cocamide Monoethanolamine (MEA)
***C12-C14 Alkyl polyglycoside
****β-Alanine, N-(2-carboxyethyl)-N-dodecyl-, monosodium salt

The stability studies took place under storage conditions with appropriate tolerances that determines the impact of temperature and humidity on shape, form, dimension, consistency, and potential transition from solid to a non-homogenous liquid dispersion state. The storage condition and the lengths of studies that were chosen to assess the tolerance of the products during shelf storage and shipment environments. Accordingly, E-6 and E-7 were examined under the 40 (±2° C.) at 75 (±0.5) % Relative Humidity (accelerated) conditions from 1 day up to 12 weeks. Such accelerated conditions correspond to a degree of stability at room temperature and room humidity ranging from 1 day to about 105 weeks respectively.

At each given time point as shown in Table 5, E-6 and E-7 were analyzed visually for its integrity, shape, form, size, dimension, solid to liquid conversion and stickiness and lifespan. The results indicated that the shapes and weights of the compositions E-6 conformed with acceptable thresholds and its integrity stayed consistent during the 12 weeks of testing. Shape was determined visually, based on the products appearance, and whether the composition loses its physical appearance from solid, semi-solid to a dispersion and/or a solution containing solid particles within the external PVOH wrapping. Stickiness and lifespan were assessed on the similar basis as in Example 1.

In contrast to E-6, the E-7 composition began to lose shape, its semi-solid consistency and lifespan properties 2 days after the composition was subjected to the accelerated testing conditions. Further, the stickiness and lifespan for E7 were not assessed throughout the 12 weeks as the product was no longer compressible once it was transitioned into a liquid dispersion. E6 on the other hand maintained its stickiness and lifespan throughout the 12 weeks being under the accelerated condition. The below tables provides a summary of the observations throughout the 12 weeks stability testing under accelerated condition.

TABLE 5

| Product | TEST CONDITIONS 40 (±2° C.) at 75 (±0.5) % RH | | | | | | |
|---|---|---|---|---|---|---|---|
| tested | Description | First day | Second Day | 2 weeks | 4 weeks | 6 weeks | 12 weeks |
| E6 | Consistency | Semi-solid | Semi-solid | Semi-solid | Semi-solid | Semi-solid | Semi-solid |
| (12 g) | | malleable | malleable | malleable | malleable | malleable | malleable |
| | | Conformed | Conformed | Conformed | Conformed | Conformed | Conformed |
| | Dimension | Conformed | Conformed | Conformed | Conformed | Conformed | Conformed |
| | Format | Hexagon | Hexagon | Hexagon | Hexagon | Hexagon | Hexagon |
| | | Conformed | Conformed | Conformed | Conformed | Conformed | Conformed |
| E7 | Consistency | Semi-solid | Dispersion/ | Dispersion/ | Dispersion/ | Dispersion/ | Dispersion/ |
| (12 g) | | malleable | liquid | liquid | liquid | liquid | liquid |
| | | (conform) | Not malleable | Not malleable | Not malleable | Not malleable | Not malleable |
| | | | (did not conform) | (did not conform) | (did not conform) | (did not conform) | (did not conform) |
| | Dimension | Conformed | Changed | Changed | Changed | Changed | Changed |
| | | | dimension | dimension | dimension | dimension | dimension |
| | | | (did not conform) | (did not conform) | (did not conform) | (did not conform) | (did not conform) |
| | Format | Hexagon | Circular | Abstract shape | Abstract shape | Abstract shape | Abstract shape |
| | | Conformed | Did not Conform | Did not Conform | Did not Conform | Did not Conform | Did not Conform |

Based on the results, the E6 provided superior stability following the 12 weeks testing at accelerated conditions. As such, E6 maintains its consistency, format, dimension and stickiness throughout a 105 weeks period at room temperature and humidity. These results also indicated that the E-7 formulations given all other conditions being constant will not withstand the shelf life, consistency, dimension, format, stickiness and life-span properties beyond the third day at normal room temperature and humidity. To that end, the composition of E-7 was not deemed suitable for long shelf storage and/or stresses associated with the packaging and shipping of the product.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A hard surface cleaning composition comprising:
a. from about 10% to about 60% by weight, preferably about 15% to about 45%, of an inorganic sodium salt;
b. from about 15% to about 75% by weight, preferably about 45% to about 70%, of anionic surfactants;
c. from about 0.1% to about 10% by weight, preferably about 0.5 to 5%, of an adhesion promoter;
d. from about 0.05% to about 10% by weight, preferably about 0.5 to 3%, of a chelating agent, and
e. from about 0.05% to about 1.0% by weight, preferably about 0.1 to about 1% of an antioxidant; and
wherein said composition is substantially free of any other surfactant source and wrapped and sealed in a water-soluble film.

2. The composition as according to claim 1, characterized in that the adhesion promoter is present in amounts ranging from about 0.5% to about 3%, more preferably from about 1.0% to about 2% by weight.

3. The composition according to claim 1, characterized in that the antioxidant is present in amounts ranging from about 0.1% to about 0.5%; more preferably in amount ranging from 0.1% to about 0.3%, by weight.

4. The composition according to claim 1, characterized in that the inorganic sodium salt is selected from the group of sodium sulfate, sodium chloride and any combinations thereof.

5. The composition according to claim 1, characterized in that the anionic surfactant is selected from the group of sodium dodecylbenzene sulfonate, sodium alpha olefin sulfonate, sodium dodecyl sulfate, sodium laurate sulfate, sodium lauryl sulfate, sodium stearate, and magnesium laureth sulfate or any combinations thereof.

6. The composition according to claim 1, wherein the ratio of the chelating agent, adhesion promoter and the antioxidant is in the ranges of 2.5 to 15:2.5 to 15:0.5 to 1.5 respectively, preferably 9 to 11:7 to 9:0.8 to 1.2 respectively, and more preferably, 10:7.5:1, respectively on a weight basis.

7. The composition according to claim 1, characterized in that the antioxidant is selected from the group of sodium phytate, butyl hydroxy toluene (BHT), hydroquinone, ditert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-proyl-gallate, citric acid, ascorbic acid, tartaric acid, adipic acid and sorbic acid, or amines like lecithin, or amino acids like glutamine, methionine and cysteine, or esters like ascorbil palmitate, ascorbil stearate and triethylcitrate, pentaerythrityl tetra-di-t-butyl hydroxyhydrocinnamate (Tinogard®), trihydroxy-flavanone, trihydroxy-methoxyflavanone, ferrolic acid, caffeic acid, Vitamins A and E, and any mixtures thereof.

8. The composition according to claim 1, wherein the composition is in the form of a solid or semi-solid.

9. The composition according to claim 1, wherein the composition is a malleable block composition.

10. The composition according to claim 1, wherein the composition is in the form of a hexagonal shape block.

11. The composition according to claim 1, wherein the water-soluble film has a thickness of about 20 to about 100 microns.

12. The composition according to claim 1, wherein the thickness of the water-soluble film at each side of the block ranges from 10 to 50 microns independently.

13. The composition according to claim 1, wherein the composition further comprises a dye, a fragrance, a biocide, preservatives, bitterness flavorants, absorbants or any mixtures thereof.

14. The composition according to claim 1, wherein the composition contains less than 2.5% water content.

15. The composition according to claim 1, wherein the composition is substantially free of bleach and any other non-ionic surfactant.

16. The composition according to claim 1, wherein the composition is a cageless and self-adhesive block composition.

17. The composition according to claim 1, where in the composition consists essentially of:
f. an inorganic sodium salt;
g. from about 25% to about 75% by weight of an anionic surfactant;
h. from about 0.5% to about 3% by weight of an adhesion promoter;
i. from about 0.5% to about 3% of a chelating agent,
j. from about 0.1% to about 1.0% by weight of an antioxidant;
k. a dye, and
l. a fragrance.
m. a water-soluble film wrapping the entire composition,
wherein said block composition adheres to sanitary object when applied directly.

18. (canceled)

19. The composition according to claim 1, wherein the composition maintains its shape, consistency and form at temperatures of 40 (±2° C.) and 75 (±0.5) % RH for 12 weeks.

20. A method of cleaning a sanitary appliance comprising creating a moist surface on the wall of a sanitary appliance, a composition according to claim 1 to the walls of a sanitary applicant by directly applying the composition to the sanitary appliance, triggering a flushing operation to release the ingredients of the block composition, wherein the block composition stays adhered to the sanitary object for at least a period of up to 7, 10, 14, 21, 28 or 60 days.

21. The method of claim 20, wherein the flushing operation is triggered up to 8 to 12 times a day.

22. The method of claim 20, wherein the sanitary appliance is of material selected from the group consisting bricks, ceramic, cement, crystal, diamond, glass, latex, marble, metallic, pebbles, porcelain, polymeric and quarry tiles, and natural stone.
